(19) United States
(12) Patent Application Publication
(10) Pub. No.: US 2008/0127300 A1
(43) Pub. Date: May 29, 2008

(54) METHOD AND APPARATUS FOR ISSUING CERTIFICATE INCLUDING LEGAL GUARDIAN'S AGREEMENT TO WARD

(75) Inventors: Seung-Hyun Kim, Daegu (KR); Jong-Hyouk Noh, Daejeon (KR); Sang-Rae Cho, Daejeon (KR); Yeong-Sub Cho, Daejeon (KR); Dae-Seon Choi, Daejeon (KR); Seung Hun Jin, Daejeon (KR); Kyo Il Chung, Daejeon (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/936,520

(22) Filed: Nov. 7, 2007

(30) Foreign Application Priority Data
Nov. 28, 2006 (KR) 10-2006-0118574

(51) Int. Cl. G06F 17/00

(52) U.S. Cl. 726/1

(57) ABSTRACT

A method and apparatus for generating a certificate including a guardian's agreement for a ward are provided. The apparatus includes a verification unit verifying a certificate of the guardian, an agreement setting unit setting an agreement on conditions on which the ward is allowed to use an online environment, and a certificate issuing unit generating a certificate including the agreement for the ward when the verification of the guardian's certificate succeeds.

### CROSS-REFERENCE TO RELATED PATENT APPLICATIONS

This application claims the benefit of Korean Patent Application No. 10-2006-0118574, filed on Nov. 28, 2006, in the Korean Intellectual Property Office, the disclosure of which is incorporated herein in its entirety by reference.

### BACKGROUND OF THE INVENTION

1. Field of the Invention

The present invention relates to a method and apparatus for generating and providing a certificate, which is a reliable means of authentication, for a ward in an online environment and for effectively managing the ward's online activities based on a legal guardian's agreement. This work was supported by the IT R&D program of MIC/IITA[2005-S-060-02, Development of Universal Security Service Platform Technology for Protecting e-Identity].

2. Description of the Related Art

In existing online environments, when a ward wants to be registered on a site, the agreement of a legal guardian is requested. At present, the ward is admitted based on the guardian's agreement received through a mobile phone or a written consent including the guardian's signature. However, this agreement and the written consent may be forged. Moreover, it often happens that wards illegally use other people's social security numbers by using illegal means, for example a social security number generator in order to be registered on online sites. In this case, wards can purchase items costing several thousand dollars using home phone or mobile phone payment. Their legal guardians can recognize problems only after they are notified to pay that money and are in financial difficulty.

According to Korean Patent Application No. 10-2001-0066884, entitled “System for Providing Identification Service Using Official Certificate Based on Public Key Infrastructure and Method Thereof”, a user's identification is verified using an official certificate issued by a certificate authority when the user accesses the Internet, so that minors are fundamentally prevented from accessing sites which identify users by checking their ages. This method uses a certificate stored in a network instead of in a user's computer, thereby controlling Internet use at the stage of accessing the Internet. However, this method still has existing inconvenient processes like identification by meeting with a registrar.

Korean Patent Application No. 10-2002-0004012, entitled “Method for Protecting an Adult Web Site”, relates to a method of isolating minors from adult web sites. Since personal information is stored in a smart card, this method originally prevents minors from attempting to access adult web sites. However, the method is restricted to some special sites and cannot be used for other web sites.

A system disclosed in Korean Patent Application No. 20-1998-0027876, entitled “System for Providing Internet Information to Restrict Minor's Internet Access”, has been suggested to effectively prevent minors from accessing adult web sites and facilitating management of adult web sites by allowing an information rating to be easily checked by color of a screen when a web site restricting the access of minors is accessed and by notifying a legal guardian by e-mail that the web site is accessed. However, the system is useless for web sites which minors can legally access.

Korean Patent Application No. 10-2002-0064114, entitled “Method of Identification on Internet”, relates to a method of easily identifying a minor on the Internet by coordinately managing all certificate information when the minor registers on an Internet site. However, the method is inconvenient as it involves sending all certificates by e-mail or facsimile when a minor wants to register on an Internet site. In addition, the method cannot prevent minors from performing jobs like payment in an online environment.

Korean Patent Application No. 10-2002-0049331, entitled “Method for Approving Service Using Mobile Communication Terminal Equipment”, relates to a method of providing an online service and a wireless payment service for a minor with a guardian's approval by using a mobile communication terminal. However, it is inconvenient to obtain a guardian's approval by using the guardian's mobile communication terminal every time a minor uses a service. In addition, it cannot be verified whether a person answering a call to the mobile communication terminal is a real guardian.

According to Korean Patent Application No. 10-2004-0061354, entitled “System and Method of Certification for Persons under Age”, a ward's certificate is connected with a payment limit and a method approved by a guardian so that the ward can reliably perform payment on online shopping sites. However, there is no way to confirm that an individual generating the ward's certificate is a legal guardian. Moreover, there is a limitation in using the system and method for universal purposes since content relating to only the amount of payment at online shopping sites is recorded on the certificate.

### SUMMARY OF THE INVENTION

The present invention provides a method of providing a reliable authentication means for a ward and a guardian's conditions for agreement in the form of a certificate in an online environment.

The present invention also provides a method of verifying a certificate including a guardian's conditions for agreement when a ward requests a service using the certificate and providing the service.

The present invention also provides an apparatus for providing a reliable authentication means for a ward and a guardian's conditions for agreement in the form of a certificate in an online environment.

The present invention also provides an apparatus for verifying a certificate including a guardian's conditions for agreement when a ward requests a service using the certificate and providing the service.

According to an aspect of the present invention, there is provided an apparatus for generating a certificate including a guardian's conditions for agreement for a ward, the apparatus including a verification unit verifying a certificate of the guardian; an policy setting unit setting an agreement on conditions on which the ward is allowed to use an online environment; and a certificate issuing unit generating a certificate including the conditions for agreement for the ward when the verification of the guardian's certificate succeeds.

According to an aspect of the present invention, there is provided an apparatus for providing a service based on a ward's certificate including a guardian's conditions for agreement, the apparatus including a certificate generation server generating and issuing the ward's certificate according to information provided by the guardian; a relationship identification unit determining whether a relationship between the guardian and the ward is lawful at a request of the certificate generation server; and a service providing server providing a service to a user submitting the ward's certificate.

According to an aspect of the present invention, there is provided a method of generating a certificate including a guardian's conditions for agreement for a ward, the method including receiving an agreement for a certificate that can be used in an online environment by a ward to be guarded by a legal guardian; verifying whether a relationship between the guardian and the ward is lawful; and generating the ward's certificate including the conditions for agreement when the relationship is verified as being lawful.

According to an aspect of the present invention, there is provided a method of providing a service based on a ward's certificate including a guardian's conditions for agreement, the method including receiving the ward's certificate signed with a certificate of the guardian; verifying whether the ward's certificate is valid; loading the conditions for agreement set by the guardian when verification of the ward's certificate succeeds; and determining whether to provide a service requested by the ward based on the conditions for agreement and providing the service.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for issuing a certificate including a guardian's conditions for agreement for a ward according to an embodiment of the present invention;

FIG. 2 is a block diagram of an apparatus for providing a service to a ward, which is included in the apparatus illustrated in FIG. 1;

FIG. 3 is a flowchart of a method of issuing a certificate to a ward according to an embodiment of the present invention; and

FIG. 4 is a flowchart of a method of providing a service using a certificate issued using the method illustrated in FIG. 3.

### DETAILED DESCRIPTION OF THE INVENTION

Hereinafter, preferred embodiments of the present invention will be described in detail with reference to the attached drawings. In the drawings, like reference numerals refer to like elements throughout.

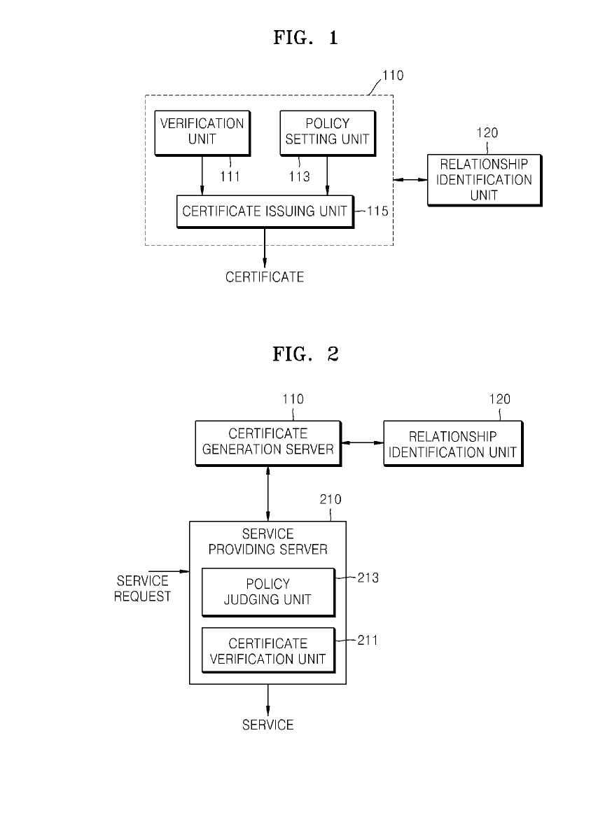

Referring to FIG. 1, a relationship identification unit 120 may be included in an apparatus 110 for generating a certificate including a guardian's conditions for agreement for a ward or may be implemented by a unit that is separate from the apparatus 110. A verification unit 111 verifies a certificate of a guardian of a ward who wants to be issued a certificate. In other words, the verification unit 111 verifies whether the guardian's certificate is valid and adds a signature to the ward's certificate. Alternatively, the verification unit 111 may sign the ward's certificate using the guardian's certificate in order to prove the clearly stated agreement of the guardian.

A policy setting unit 113 receives conditions on which the ward is allowed to use an online environment from a guardian, sets policy including the conditions, and outputs the conditions for agreement to a certificate issuing unit 115. The policy includes information such as guardian information like contact information, effective duration of a certificate, names of sites or site groups available with the certificate (e.g., sites or games available to minors under age xx), a payment scheme and limit amount, and a total use time or a use time zone with respect to online sites.

The certificate issuing unit 115 generates and outputs a certificate including the conditions for agreement for the ward when the verification unit 111 succeeds in verification.

The relationship identification unit 120 identifies the legal relationship between the guardian and the ward and provides a result of the identification to the certificate issuing unit 115.

Referring to FIG. 2, an apparatus for providing a service to a ward includes the apparatus 110 illustrated in FIG. 1, which may be referred to as a certificate generation server 110 based on the fact that the present invention relates to a system for providing an online service through the Internet, a service providing server 210 providing a service at the request of a ward, and the relationship identification unit 120.

As described above, the relationship identification unit 120 provides a service of identifying the legal relationship between a guardian and a ward. The service may be placed inside or outside the certificate generation server 110 so as to transmit a response at the request of the certificate generation server 110. When it is judged that legal identification is not necessary, the relationship identification unit 120 may be omitted.

The service providing server 210 includes a certificate verification unit 211 and a policy judging unit 213. The certificate verification unit 211 receives a ward's certificate and verifies the validity of the ward's certificate. The policy judging unit 213 loads conditions for agreement stored in the ward's certificate and determines whether to accept the ward's request for performing a job. The job may be registering or logging on to a site or carrying out payment.

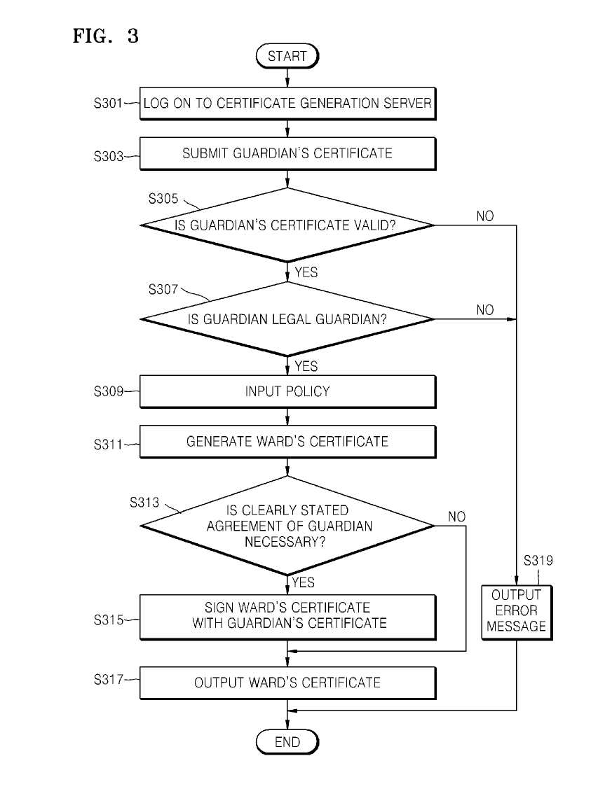

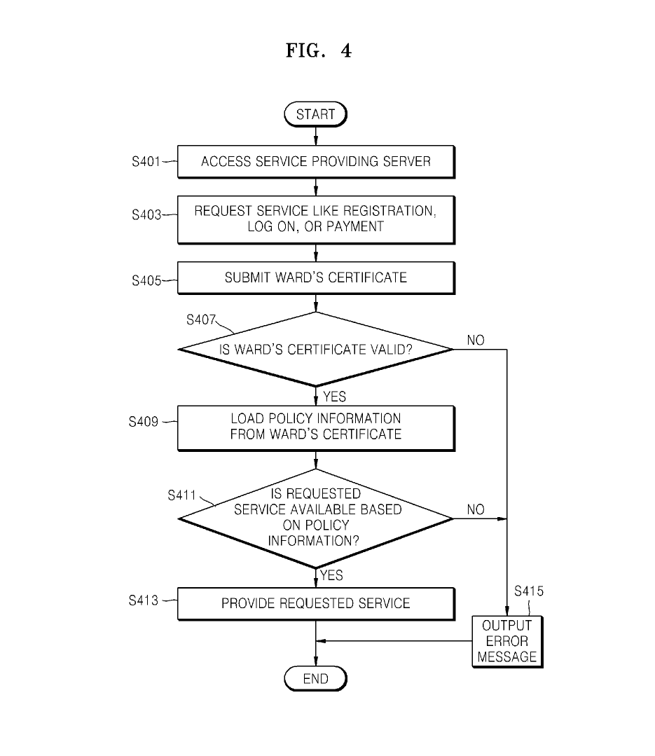

Hereinafter, a method of issuing a certificate including a guardian's conditions for agreement to a ward and a method of providing a service, according to embodiments of the present invention, will be described in detail with reference to FIG. 3 and FIG. 4.

FIG. 3 illustrates operations in which a guardian issues a certificate to a ward using the certificate generation server 110. In operation S301, a guardian logs on to the certificate generation server 110. Before a certificate is issued to a ward, the guardian's certificate is submitted in operation S303 and it is verified whether the guardian's certificate is effective in operation S305. When the guardian is identified, a job of generating a certificate for the ward is carried out. At this time, it may be verified whether the guardian is a legal guardian of the ward in operation S307. When the guardian inputs a policy (that is, conditions for agreement) for controlling the ward's online environment in operation S309, the certificate generation server 110 generates a certificate for the ward in operation S311. When it is determined that a clearly stated agreement of the guardian is necessary in operation S313, a signature may be added to the ward's certificate using the guardian's certificate in operation S315. When the signature of the guardian is added to the ward's certificate, it may be confirmed that the guardian's agreement is evident through verification of the guardian's signature when a service is provided to the ward. In operation S317, the ward's certificate is completed and transmitted to the ward. When a problem occurs while the operations are being performed, an error message is output in operation S319.

FIG. 4 illustrates operations in which the ward uses the service providing server 210 (which corresponds to an online site providing a service) using the ward's certificate. In operation S401, the ward accesses the service providing server 210. When the ward requests a service such as registration, log on, or payment in operation S403, the service providing server 210 requests the ward's certificate. When the ward submits the certificate in operation S405, the service providing server 210 verifies whether the certificate effective operation S407 and loads information on the conditions for agreement stored in the certificate in operation S409 when it is verified that the certificate is valid. The service providing server 210 determines whether to provide the service requested by the ward based on the agreement information in operation S411 and provides the requested service in operation S413. When a problem occurs while the operations are performed, an error message is output in operation S415.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and carrier waves (such as data transmission through the Internet). The computer readable recording medium can also be distributed over network coupled computer systems so that the computer readable code is stored and executed in a distributed fashion. In addition, a font ROM data structure according to the present invention can be embodied as computer readable codes on a computer readable recording medium such as ROM, RAM, CD-ROM, a magnetic tape, a hard disk, a floppy disk, flash memory, or an optical data storage device.

As described above, the present invention provides a safe online environment for a ward using a certificate including a guardian's conditions for agreement. In conventional technology, there is a possibility of forgery and illegal use of a certificate when a telephone or facsimile is used in order to obtain a guardian's approval and there is a problem in that a ward may use another person's social security number by stealth in order to avoid the approval of a guardian. However, the present invention allows a ward to freely use an online environment without repeated approval of a guardian since a certificate is issued to the ward and rarely allows the possibility of forgery and illegal use of the certificate because the guardian's certificate is used to issue the ward's certificate.

The conventional technology has difficulties in controlling the ward's online environment because blocking access to a particular site on a predetermined computer is the only way of controlling the ward's online environment. However, according to the present invention, since an agreement stating specified conditions agreed by the guardian is recorded in the ward's certificate, the online environment can be universally and entirely controlled. When payment is carried out through a different terminal such as a home phone or a mobile phone, it can be processed based on a payment limit recorded in the ward's certificate. Also, when the ward wants to be registered on an online site, acceptance can be determined based on an age recorded in the ward's certificate.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for generating a certificate including a guardian's condition for agreement for a ward, the apparatus comprising:
a verification unit verifying a certificate of the guardian;
an policy setting unit setting the conditions for agreement on which the ward is allowed to use an online environment; and
a certificate issuing unit generating a certificate including the conditions for the ward when the guardian's certificate is verified.

2. The apparatus of claim 1, further comprising a relationship identification unit identifying a legal relationship between the guardian and the ward.

3. The apparatus of claim 1, wherein the conditions comprises information on the guardian, information on the guardian's certificate, a list of sites accessible with the ward's certificate, and a payment scheme.

4. An apparatus for providing a service based on a ward's certificate including a guardian's conditions for agreement, the apparatus comprising:
a certificate generation server generating and issuing the ward's certificate according to information provided by the guardian;
a relationship identification unit determining whether a relationship between the guardian and the ward is lawful at a request of the certificate generation server; and
a service providing server providing a service to a user submitting the ward's certificate.

5. The apparatus of claim 4, wherein the certificate generation server comprises:
a verification unit verifying a certificate of the guardian;
a policy setting unit setting conditions for agreement on which the ward is allowed to use an online environment; and
a certificate issuing unit generating a certificate including the conditions for the ward when the guardian's certificate is verified.

6. The apparatus of claim 5, wherein the conditions for agreement comprises information on the guardian, information on the guardian's certificate, a list of sites accessible with the ward's certificate, and a payment scheme.

7. The apparatus of claim 4, wherein the service providing server comprises:
a certificate verification unit receiving the ward's certificate and verifying whether the ward's certificate is valid; and
an policy judging unit loading the conditions for agreement included in the ward's certificate when the certificate verification unit succeeds in the verification and provides the service according to the agreement.

8. A method of generating a certificate including a guardian's conditions for agreement for a ward, the method comprising:
receiving conditions for agreement for a certificate that can be used in an online environment by a ward to be guarded by a legal guardian;
verifying whether a relationship between the guardian and the ward is lawful; and
generating the ward's certificate including the conditions for agreement when the relationship is verified as being lawful.

9. The method of claim 8, wherein the receiving of the conditions for agreement comprises receiving a certificate of the legal guardian and continuing processes when the guardian's certificate is valid.

10. The method of claim 8, wherein the verifying whether the relationship is lawful comprises identifying the relationship between the ward and the guardian based on information that can prove a parent-child relationship or a legal guardian-ward relationship or personal information including a social security number.

11. The method of claim 8, further comprising signing the ward's certificate using a certificate of the guardian.

12. A method of providing a service based on a ward's certificate including a guardian's conditions for agreement, the method comprising:
receiving the ward's certificate signed with a certificate of the guardian;
verifying whether the ward's certificate is valid;
loading the conditions for agreement set by the guardian when verification of the ward's certificate succeeds; and
determining whether to provide a service requested by the ward based on the agreement and providing the service.

13. The method of claim 12, wherein the loading the conditions for agreement comprises loading the conditions for agreement based on information included in the ward's certificate.
